(19) United States
(12) Patent Application Publication
(10) Pub. No.: US 2026/0293906 A1
(43) Pub. Date: Oct. 1, 2026

(54) Antibacterial Applications of Titanate Nanofilaments

(71) Applicant: Drexel University, Philadelphia, PA (US)

(72) Inventors: Mohammad MOZAFARI, Philadelphia, PA (US); Mohamed Ahmed IBRAHIM, Philadelphia, PA (US); Masoud SOROUSH, Blue Bell, PA (US); Michel W. BARSOUM, Moorestown, NJ (US)

(21) Appl. No.: 19/631,195

(22) Filed: Mar. 27, 2026

Related U.S. Application Data
(60) Provisional application No. 63/778,850, filed on Mar. 27, 2025.

(51) Int. Cl. A01N 59/16; A01P 1/00

(52) U.S. Cl. CPC A01N 59/16; A01P 1/00

(57) ABSTRACT

A method of bacterial population inactivation, comprising: contacting the bacterial population and a plurality of one-dimensional lepidocrocite titanate nanofilaments under such conditions that at least a portion of the bacterial population is inactivated. The inactivation can take place under ambient lighting conditions or even in reduced light or dark.

### RELATED APPLICATIONS

The present application claims priority to and the benefit of U.S. patent application No. 63/778,850, “Antimicrobial Properties Of Quantum-Confined One-Dimensional Titania Nanofilaments” (filed Mar. 27, 2025). All foregoing applications are incorporated herein by reference in their entireties for any and all purposes.

### TECHNICAL FIELD

The present disclosure relates to the field of titanate materials and to the field of antibacterial compositions and methods.

### BACKGROUND

The emergence of antimicrobial resistance demands fundamentally new classes of antibacterial materials that operate through mechanisms distinct from conventional chemical or photodynamic pathways. Accordingly, there is a long-felt need in the field for antibacterial compositions and methods.

### SUMMARY

In meeting the described long-felt needs, the present disclosure provides a method of bacterial population inactivation, comprising: contacting the bacterial population and a plurality of one-dimensional lepidocrocite titanate nanofilaments under such conditions that at least a portion of the bacterial population is inactivated.

Also provided is a composition, comprising: a bacterial population; and a plurality of one-dimensional lepidocrocite titanate nanofilaments.

Further provided is an antibacterial surface comprising: a substrate; and a coating disposed on the substrate, the coating comprising one-dimensional lepidocrocite titanate nanofilaments, the nanofilaments being configured to mechanically disrupt bacterial cell membranes with contact.

Additionally disclosed is an antibacterial material comprising: a gel or porous mesostructured particle comprising one-dimensional lepidocrocite titanate nanofilaments, the nanofilaments being configured to mechanically disrupt bacterial cell membranes with contact.

Also provided is a purification system, comprising: a filtration medium containing one-dimensional lepidocrocite titanate nanofilaments, the nanofilaments being configured to mechanically disrupt bacterial cell membranes with contact.

Further provided is a component, comprising: a substrate; and one-dimensional lepidocrocite titanate nanofilaments disposed in or on the substrate, the nanofilaments being configured to mechanically disrupt bacterial cell membranes with contact, and the one-dimensional lepidocrocite titanate nanofilaments optionally being comprised in a coating.

Also disclosed is a method, comprising: suspending a plurality of one-dimensional lepidocrocite titanate nanofilaments so as to give rise to an antibacterial suspension of the one-dimensional lepidocrocite titanate nanofilaments.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1. Characterization of 1DLs. (a) XRD patterns of Cho-1DL, TMA-1DL, Na-1DL, and K-1DL. Asterisks (*) indicate peaks corresponding to unreacted TiB₂. (b) TEM image of TMA-1DL colloidal suspension. (c) SEM image of a Na-PMP.

FIG. 2. Concentration-dependent AB activity of TMA-1DL NFs. Photographs of agar plates showing E. coli, B. subtilis, and L. innocua bacterial cells (final concentration 10⁶ CFU/mL) re-cultivated after 4 h of treatment starting with concentrations of TMA-1DL indicated. Bacterial suspensions (final concentration 10⁶ CFU/mL) in DI water without TMA-1DL material served as controls.

FIG. 3. AB activity against E. coli, B. subtilis, and L. innocua (10⁶ CFU/mL) after 4 h of incubation. CFU assay showing the effect of, (a) TMA-1DL NFs at various concentrations, (b) Same as a, but using Cho-1DL, re-cultivated with 1000 μg/mL. (c) Flow cytometry analysis of bacteria exposed to 1000 μg/mL TMA-1DL in the dark. Histograms depict bacteria treated with TMA-1DL (red) and untreated control (blue). Insets show autofluorescence histograms of unstained bacteria for comparison.

FIG. 4. SEM images of bacteria aggregates formed through interaction with TMA-1DL colloid at different magnifications (a-c) E. coli, (d-f) B. subtilis, and (g-i) L. innocua aggregates. Bacterial adsorption on 1DL-Col surfaces. High 1DL surface area enables efficient bacterial capture, and aggregation.

FIG. 5. SEM images of bacteria treated with 1000 μg/mL of TMA-1DL NFs. Treated bacterial cells exhibit extensive cell lysis, as evidenced by severe membrane disruption and cytoplasmic leakage (indicated by red arrows).

FIG. 6. TEM images of E. coli, (a) untreated (control) showing intact bacterial cell membranes and a uniform morphology, (b) and (c) after treatment with 1DL NFs, showing significant membrane disruption presumably induced by direct physical interactions.

FIG. 7. Characterization of 1DLs. (a) DFT model of 1DL structure showing 2× 2 sharing edges TiO₆ octahedra growing along [100], (b) the a-b plane depicting a and b lattice parameters, (c) the b-c plane showing the c lattice parameter, and (d) the a-c plane.

FIG. 8. Schematic illustration of the synthesis procedure for 1DL NFs and Na- and K-PMPs.

FIG. 9. Illustration of colony-forming unit (CFU) counting process. Cells from untreated and 1DL NFs treated samples are serially diluted (1:4), and 100 μL of each dilution is spread on agar plates to form colonies overnight. The colonies are then counted. Each colony corresponds to a single viable cell, providing an estimate of the bacterial concentration in the sample.

FIG. 10. Typical SEM images of K-1DL PMPs. Morphology is similar to that of its Na-counterpart shown in FIG. 1c.

FIG. 11. (a) Inactivation efficiency of TMA-1DL (1000 μg/mL) against E. coli (final concentration of 10⁶ CFU/mL) after 3 h of incubation, sonicated for the indicated durations (0, 1.5, 3, and 8 h). (b) E. coli bacterial cells were recultivated after treatment with 1000 μg/mL of TMA-1DL for 0 to 5 h incubation time.

FIG. 12. Optical images of E. coli, B. subtilis, and L. innocua bacterial cells (final concentration 10⁶ CFU/mL) re-cultivated after 4 h of treatment with 2000 μg/mL TMA-1DL, showing bacterial agglomeration. Bacterial suspensions (final concentration 10⁶ CFU/mL) in DI water without TMA-1DL served as a control.

FIG. 13. (a) Antibacterial activity of TMA-1DL (1000 μg/mL) against E. coli, B. subtilis, and L. innocua bacterial cells (final concentration 10⁶ CFU/mL) for 4 h in DI water instead of PBS. (b) Photographs of corresponding agar plates. Bacterial suspensions (final concentration 10⁶ CFU/mL) in DI water without TMA-1DL material served as controls.

FIG. 14. (a) Photographs of agar plates and (b) optical images of E. coli, B. subtilis, and L. innocua bacterial cells (final concentration 10⁶ CFU/mL) recultivated after 4 h of treatment with 1000 μg/mL Cho-1DL. Bacterial suspensions (final concentration 10⁶ CFU/mL) in DI water without Cho-1DL served as controls.

FIG. 15. Antibacterial activities of NaCl-1DL and KCl-1DL PMPs. E. coli bacterial cells (final concentration 10 CFU/mL) were recultivated with 1000 μg/mL NaCl-1DL and KCl-1DL materials for 4 h of incubation.

FIG. 16. Formation of superoxide radicals (O^{2·-}) evaluated by the XTT reduction assay in the dark. XTT (0.4 mM, pH 7.0) was incubated with 1DL NF colloidal suspensions at various concentrations for up to 4 h. Commercial P25 TiO₂ (1000 μg mL-1) was used as a positive control.

FIG. 17. Percentage of dead/damaged bacterial cells for each strain after 4 h in the dark, as determined by flow cytometry.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments or aspects can be combined with any part or parts of any one or more other embodiments or aspects.

The emergence of antimicrobial resistance demands fundamentally new classes of antibacterial materials that operate through mechanisms distinct from conventional chemical or photodynamic pathways. Here, we introduce quantum-confined, one-dimensional lepidocrocite titanate nanofilaments (1DL NFs) as a previously unexplored inorganic nanomaterial platform that inactivates bacteria through direct contact-mediated membrane disruption. The 1DL-Ti NFs exhibit potent antibacterial activity against Escherichia coli, Bacillus subtilis, and Listeria innocua, achieving ~96-99% inactivation within 4 h under ambient light and ~85% in the dark, revealing light-independent efficacy. Multiparametric analyses-including reactive oxygen species assays, flow cytometry, and high-resolution electron microscopy-demonstrate a unique physical mechanism in which 1DL NFs result in membrane impalement, cell entrapment, and rapid biofilm-like agglomeration, distinct from ion- or reactive oxygen species-driven bactericidal pathways.

Metal-ion release studies confirmed negligible leaching, ruling out ion-mediated toxicity. This “all-surface” architecture, enabled by the atomically thin one-dimensional structure of the nanofilaments, differentiates them from conventional TiO₂ nanocrystals and promotes strong interfacial contact with bacterial membranes. The synthesis is solution-based, low-temperature, highly scalable, and tolerant to the presence of several interlayer cations, providing modularity and manufacturability. These findings establish 1DL NFs as a new class of inorganic antibacterial materials with transformative potential for smart antimicrobial coatings, biomedical interfaces, water purification, and food-safety applications.

The escalating prevalence of antibiotic-resistant bacteria poses significant challenges to global healthcare and environmental safety. The rapid emergence of multidrug-resistant strains undermines the effectiveness of conventional antibiotics, necessitating innovative approaches to combat bacterial infections. Nanomaterials have emerged as promising candidates, offering broad-spectrum antibacterial, AB, activity through mechanisms such as membrane disruption, oxidative stress induction, and biofilm penetration. They can effectively target antibiotic-resistant strains and biofilm-associated infections, positioning them as potent agents in next-generation AB therapies.

Among advanced nanomaterials, titanium dioxide (TiO₂) has gained attention as a versatile and eco-friendly option owing to its high chemical stability and safety. Several studies have proposed mechanisms behind its AB properties, including physical interactions between bacteria and nanomaterials, as well as the generation of reactive oxygen species (ROS). Upon light activation, TiO₂ produces ROSs that effectively disrupt bacterial membranes, degrade biofilms, and inactivate pathogens. These characteristics, coupled with its excellent safety profile, render TiO₂ a leading candidate for diverse applications, including healthcare disinfection and environmental remediation. Because of its remarkable properties, substantial efforts have been dedicated to synthesizing and tailoring the TiO₂ nanostructures to enhance their AB performance. However, conventional Ti-based antibacterial materials, including anatase, rutile, P25 TiO₂ nanoparticles, and TiO₂ nanotubes, typically require UV illumination to reach meaningful antibacterial efficiencies. Their activity under ambient light is greatly diminished, and their dark antibacterial performance is generally minimal. Even TiO₂ compositions modified with silver via sol-gel/hydrothermal synthesis, photodeposition, or chemical reduction still show limited intrinsic efficacy without light exposure. These limitations highlight the absence of a Ti-based antibacterial material that is both potent and light-independent, underscoring the need for fundamentally new Ti-based architectures capable of robust antibacterial performance under practical, low-light or dark conditions.

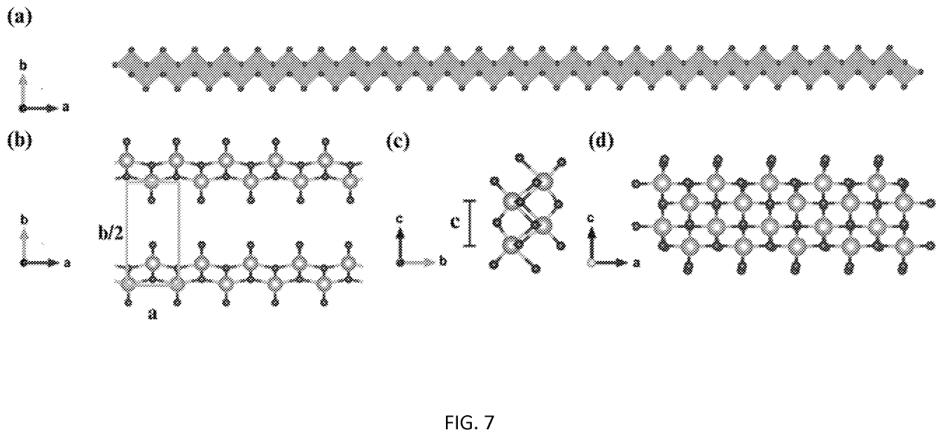

One-dimensional lepidocrocite titanate nanofilaments (1DL NFs) is a new class of nanomaterials, which are produced using a simple, one-pot, scalable method capable of producing the nanomaterials at the kilogram scale. This method involves reacting Ti-containing precursors with tetraalkylammonium hydroxides (TAAH) at temperatures not exceeding 80° C. These 1DL NFs consist of 2×2 TiO₆ octahedra with cross-sections of ~5×7 Å² and lengths of tens of nanometers (FIGS. 7a-7d), representing a lepidocrocite-type titanate structure distinct from conventional TiO₂ polymorphs. The flocculation of the 1DLs upon the addition of cationic dyes to colloidal suspensions is a notable phenomenon. This immediate aggregation is visible to the naked eye and is primarily driven by electrostatic interactions, as the negatively charged 1DLs attract the positively charged dye molecules. In contrast, when anionic dyes are introduced, no flocculation occurs, underscoring the specificity of this interaction. This behavior has been observed in studies where 1DLs demonstrated high affinity for cationic dyes such as rhodamine 6G, crystal violet, and malachite green, with a maximum uptake exceeding 1,850 mmol·kg⁻¹, 1,930 mmol·kg⁻¹, and 2,061 mmol·kg⁻¹, respectively, primarily via ion exchange mechanisms.

In the present disclosure, we illustrate the AB activity of 1DL titanate NFs synthesized using Tetramethylammonium hydroxide (TMAOH) or Choline hydroxide (ChoOH). To assess the influence of intercalated cations on the AB properties, the original TMA⁺ cations are exchanged with potassium (K⁺) or sodium (Na⁺), creating K-1DL and Na-1DL variants. The AB activity of these materials is evaluated against model Gram-negative Escherichia coli (E. coli) and the Gram-positive Bacillus subtilis (B. subtilis) and Listeria innocua (L. innocua). We examine the antibacterial activity, ABA, in relation to NF size, incubation duration, and concentration, using colony-forming units (CFU) assays. To elucidate the potential AB modes-of-action, flow cytometry and reactive oxygen species (ROS) assays are further employed. Our findings suggest that 1DL NFs represent a new class of AB nanomaterials with significant potential applications in AB treatments and water purification.

### Materials and Methods

### Materials Processing

The choice of the tetraalkylammonium hydroxide (TAAH) can influence synthesizing and tuning 1DL NFs. These hydroxides dissolve titanium precursors into TiO₆ octahedra and direct their growth into 1D structures, with the specific TAAH strongly influencing the final material. Smaller, hydrophilic TAAHs such as TMAOH produce an interlayer spacing of 11.5 Å, whereas larger TAAHs like TPAOH expand it to 14.8 Å, yielding less hydrophilic NFs that can suspend in organic solvents.

Using choline hydroxide produces an environmentally benign 1DL material because choline is a naturally occurring essential nutrient, offering chemical stability and low toxicity rather than from toxic cations such as TMA⁺. Post-synthesis processing further shapes morphology: the self-assembly of 1DL NFs depends strongly on the solvent used during washing and drying. Washing TMA-1DLs with ethanol and drying yields porous mesostructured particles (PMPs) with spherical-like morphologies, whereas washing with water forms stable colloidal suspensions. Small-angle X-ray scattering shows that, in suspension, some 1DLs assemble into ribbons of ~5-8 NFs, ~300 Å long and one lepidocrocite sheet (≈5 Å) thick. These ribbons align along the a-axis, form nanobundles, and, upon drying, coalesce into sheets that stack along the b-axis. Stacking depends on interlayer cations: TMA⁺ induces ABABA ordering, while Li⁺ yields AAA.

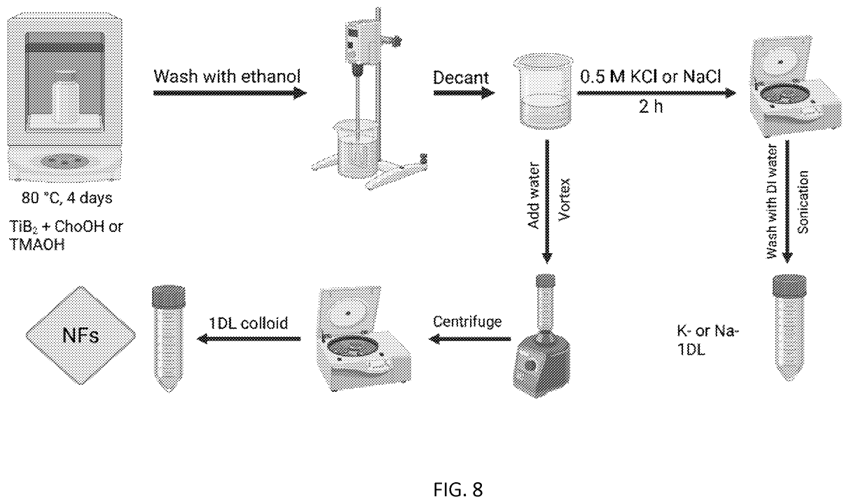

A schematic illustration of the synthesis procedures for 1DL NFs and Na- and K-PMPs is provided in FIG. 8. TiB₂ powder (as-received, 99.9% purity, −325 mesh, Thermo Fisher Scientific Inc.) was mixed with either 25 wt. % aqueous TMAOH (as-received, 99.9999%, Alfa Aesar, USA) or 46 wt. % aqueous choline hydroxide (ChoOH) (as-received, Thermo Fisher Scientific, USA) solutions in 250 mL polyethylene bottles. The TiB₂ to TMAOH/ChoOH molar ratio was kept at 0.6. The resulting material is thus well characterized and understood. Specifically, 10 g of TiB₂ was added to 100 mL of TMAOH or 60 mL of ChoOH. The mixture was heated and agitated in an incubator (Labnet International Shaking Incubator, NJ, USA) at 180 rpm and 80° C. for four days, d, with the bottles vented using two 23-gauge needles. (Caution: The reaction generates H₂ and other gases that if not vented can explode violently)

Post-reaction, the resulting sediment was transferred to a 1 L beaker, mixed with ethanol, EtOH (200 proof, Decon Lab), and stirred at ambient temperature for five minutes using an overhead mixer (OSC-10L-200 rpm, LabFish, China). The powder was allowed to settle, and the supernatant, containing excess TMA⁺/Cho⁺ cations and other water-soluble byproducts, was discarded. This washing procedure was repeated several times until a neutral pH was achieved. This synthesis approach results in the formation of 1DL NFs through the reaction of TiB₂ with TMAOH or ChoOH.

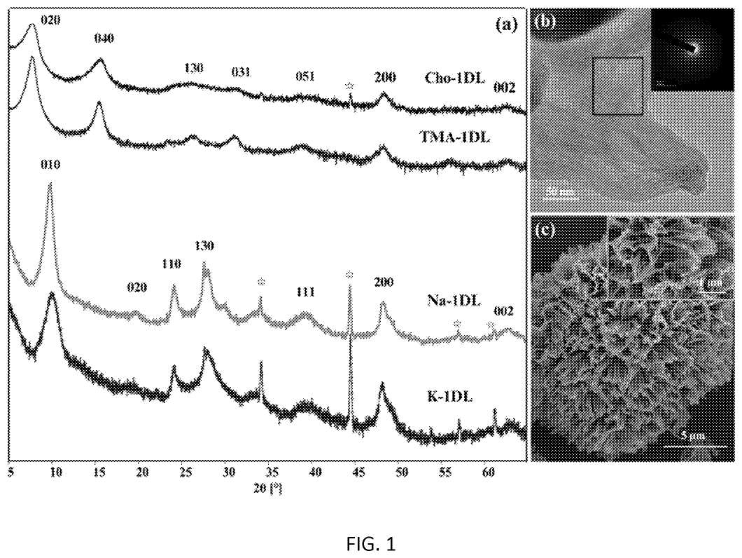

To prepare PMPs, the EtOH-washed sediments were allowed to dry in open air at 50° C. after the final EtOH wash. This drying process results in PMPs with spherical-like morphologies (see e.g. FIG. 1c). Alternatively, to obtain colloidal suspensions, 15 mL of the EtOH-washed sediment was transferred into a 50 mL tube and centrifuged at 3500 rpm for 1 minute to remove excess EtOH; the supernatant was discarded. Water was then added, and the material was resuspended by vortex shaking.

After centrifugation at 5000 rpm for 1 h, a highly stable aqueous colloidal suspension was obtained, while any unreacted TiB₂ settled at the bottom of the centrifuge tube and was discarded. The concentration of the colloidal 1DLs was determined by vacuum filtering 1 mL of the suspension through a 25 μm thick microporous monolayer polypropylene membrane (Celgard® 3501, Celgard, NC, USA) using a fritted glass filter apparatus. The filtered films were fully dried in a vacuum oven at 80° C. overnight, and the weight of the residue was measured to quantify the 1DL colloidal concentrations.

To synthesize K-1DL and Na-1DL PMPs, 2 g of EtOH-washed TMA-1DL sediment, while still wet, was placed in 50 mL of 0.5 M KCl or 50 mL of 0.5 M NaCl solution in a reaction bottle and stirred using a magnetic stirrer for 2 h. The mixture was transferred to a centrifuge tube for washing. The sediment was washed with DI water (4 cycles) to ensure the removal of excess salt. To enhance the dispersibility of K-1DL and Na-1DL, the wet washed PMPs were transferred to a 100 mL glass beaker and sonicated using a probe sonicator (Fisherbrand™ Model 505 Sonic Dismembrator, Pittsburgh, USA) at 70% power, operating in intervals of 40 s on, and 10 s off, for a total duration of 40 minutes.

### Characterizations

The TMA- and Cho-1DL colloid suspensions were vacuum-filtered and dried at 50° C. overnight. The resulting filtered films, FFs, were finely ground into powders using a mortar and pestle to ensure uniformity for subsequent analyses. For K⁺- and Na⁺-intercalated PMPs, X-ray diffraction (XRD) patterns were obtained from intercalated PMPs powders after drying at 50° C. for 24 h. The patterns were obtained using a diffractometer (Rigaku MiniFlex, Japan) equipped with Cu K_{α} radiation source, operating at 40 kV and 15 mA. Scans were conducted over a 20 range of 5°-65° with a step size of 0.02° and a dwell time of 1 s.

A scanning electron microscope (SEM) was employed to observe the morphology and surface characteristics of the samples. Micrographs were acquired using a field emission scanning electron microscope (FE-SEM), (Zeiss Supra 50 VP, Carl Zeiss SMT AG in Oberkochen, Germany). Prior to imaging, samples were sputter-coated with a platinum/palladium (Pt/Pd) layer for 30 s at 40 mV using a sputter coater (Cressington 208 HR) to enhance conductivity and image quality. The SEM was operated at an accelerating voltage of 10 kV, utilizing the ‘Inlens’ detector setting to optimize image clarity and detail.

A transmission electron microscope (TEM) was also used to image some samples. A field-emission TEM (JEOL JEM2100F Akishima, Tokyo, Japan), operated at an accelerating voltage of 200 keV, achieving an image resolution of approximately 0.2 nm was used. Images and diffraction patterns were recorded using a Gatan USC1000 CCD camera. To prepare samples for TEM analysis, approximately 10 μL aliquots of E. coli suspensions, with and without exposure to 1DL NFs, were drop-cast onto carbon-coated mesh grids. The grids were subsequently air-dried at room temperature for 2 h before TEM imaging.

### Bacteria Cell Preparation

E. coli (MG1655, Drexel Medicine College, Gram-negative), B. subtilis (ATCC 6051, Gram-positive), and L. innocua (ATCC 51742, Gram-positive) were cultured in a Luria-Bertani (LB) medium at 37° C. overnight. The cultures were subsequently subcultured and harvested at the exponential growth phase. Cells were centrifuged at 5000 rpm for 10 min, and the resulting pellets were washed three times with phosphate-buffered saline (PBS, pH 7.4, Sigma-Aldrich, Germany) to remove residual medium and macromolecules. Finally, the pellets were resuspended in deionized (DI) water and diluted to achieve an approximate bacterial concentration of 10⁸ CFU/mL.

### Antibacterial Activity of 1DL

The AB activity against each strain was assessed using the CFU technique.

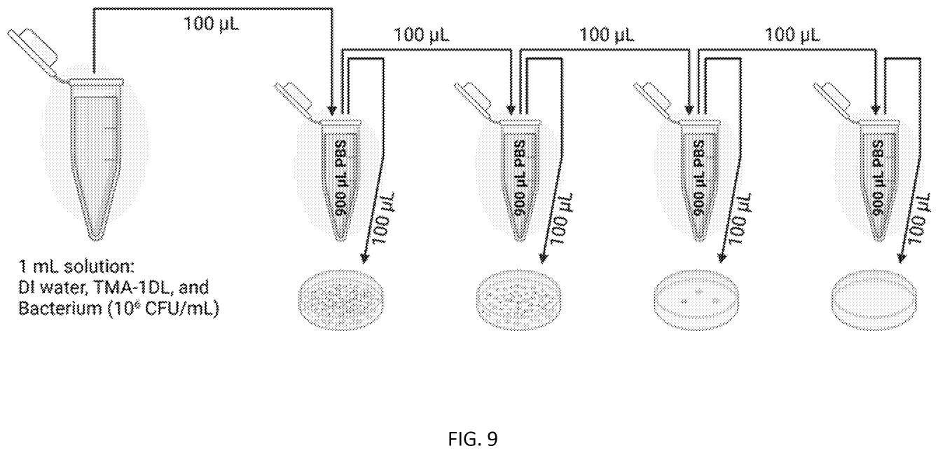

The assays compare the AB efficacy of TMA-1DL, Cho-1DL colloids and Na-1DL, K-1DL PMPs. Bacteria, at a final concentration of 10⁶ CFU/mL, were incubated at 150 rpm and room temperature, RT, with varying concentrations (200-2000 μg/mL) of TMA-1DL for different durations (0-5 h). After optimizing concentrations and incubation times, the AB activity of the Na-1DL, K-1DL, and Cho-1DL samples were further evaluated. Subsequently, 100 μL of the cultures were plated on LB agar plates (FIG. 9) and incubated for ~18 h. The number of colonies formed was counted and compared with the control to calculate the bacterial inactivation percentage defined by:

$$Inactivation percentage ( \% ) = [ 1 - ( \frac{{A}_{m}}{{A}_{c}} ) ] \times 100$$

where Aₘ and A_{c} represent the number of colonies on the 1DL-treated and control plates, respectively. Because the as-prepared 1DL colloidal suspensions are alkaline (pH≈10), it was important to verify that the observed ABA was not a pH-driven artifact. Therefore, for all CFU assays, the 1DL colloids were diluted into PBS (pH 7.4) under identical conditions. The pH of the resulting bacteria-1DL mixtures was measured immediately after mixing (pH 7.47) and again after 4 h of incubation (pH 7.56). In both cases, the pH remained within the physiological range and was indistinguishable from control samples containing only bacteria in PBS. All experiments were repeated three times, with three measurements taken per experiment; the average values are reported here.

### Flow Cytometry of Bacteria

Cells of E. coli and L. innocua at a concentration of 10⁸ CFU/mL were exposed to TMA-1DL at final concentrations of 1000 μg/mL, in a 96-well microtiter flat-bottom plate. The plate, containing both treated and untreated samples, was incubated at 150 rpm and RT for 4 h in complete darkness. Cell viability was assessed using flow cytometry (FC, BD FAC Symphony A1). For this, samples were incubated with 30 μL of propidium iodide for 15 min in the dark at RT. FC analyses were performed with a medium fluid rate, and a limit of 100,000 events was set for each trial. To minimize interference from debris, two thresholds were applied: forward angle scattering height (FSC-H) for signals greater than 10,000 and side-angle scattering height (SSC-H) for signals exceeding 100 were selected. The propidium iodide was excited with a 15 mW argon, Ar, ion laser (488 nm), and the fluorescence was detected using a FL2 channel, with a detection wavelength of 585±40 nm. Fluorescence signals were amplified using the logarithmic mode and are displayed on a logarithmic scale. For single-cell analyses, an FSC-H vs. FSC-A (A stands for the area of the signals) scatter plot was utilized to exclude doublets, which appeared as a distinct population with higher area values.

### Superoxide Radical (O^{2·-}) Assay

The potential formation of superoxide radical anions (O^{2·-}) by 1DL NFs was evaluated using the XTT reduction method. The tetrazolium salt XTT (2,3-bis(2-methoxy-4-nitro-5-sulfophenyl)-2H-tetrazolium-5-carboxanilide, Fluka) is selectively reduced by (O^{2·-}) to form a water-soluble orange formazan product that exhibits a maximum absorption at 470 nm. A 0.4 mM XTT solution was prepared in phosphate-buffered saline (PBS, pH 7.0). Bacterial dispersions (1 mL) treated with 1DL NFs at different concentrations were mixed with 1 mL of the XTT solution and incubated for 0-4 h at RT in the dark. Following incubation, the suspensions were filtered through a 0.45 μm polyethersulfone (PES) membrane filter (Whatman) to remove residual NFs or other small solid particles. The absorbance of the filtrate was recorded at 470 nm using a UV-Vis spectrophotometer (Cary 60, Agilent Technologies, Santa Clara, CA, USA) at a scan rate of 300 nm·min⁻¹. The increase in absorbance relative to the control (XTT solution without 1DL NFs) was used to estimate the relative (O^{2·-}) generation under the tested conditions. We also tested P25 as a positive control.

Quantification of Titanium Ion Release from 1DL-NFs Using ICP-QQQ Analysis

To quantify potential Ti ion release from the 1DL NFs, an inductively coupled plasma triple quadrupole (ICP-QQQ) mass spectrometer was utilized. Following incubation of aqueous suspensions of 1DL NFs with bacterial strains under conditions identical to those previously described, aliquots (0.5 mL) were collected and passed through a 0.22 μm syringe filter to remove bacterial cells and any aggregates. The filtered aliquots were then diluted to a final volume of 50 mL with ultrapure water yielding a Ti-concentration of approximately 10 ppm, based on an assumed initial colloidal concentration of 1 mg/mL.

Calibration standards (10 ppm, 1 ppm, and 100 ppb) were prepared from a commercially available single-element Ti standard solution (Agilent 5190-8545, initial concentration 1 mg/mL) using serial dilution. ICP-QQQ analyses were conducted using an ICP instrument (8900 ICP-QQQ, Agilent Technologies, Santa Clara, CA, USA) equipped with an SPS 4 autosampler, operating in helium (He) collision mode to minimize polyatomic interferences and optimize detection accuracy. DI water served as the analytical blank.

### Results and Discussions

### Characterizations of 1DL NFs

FIG. 1a displays typical XRD patterns of the materials investigated in this study. The top two patterns correspond to the Cho-1DL and TMA-1DL powders and exhibit notable similarities. The d calculated from the (020) peak, remained constant at ~11.5 Å, attributed to the comparable sizes of TMA⁺ and Cho⁺ cations situated between the NFs. The patterns for the powders intercalated with Na- and K-1DLs are shown in the bottom two patterns in FIG. 1a. Because of their smaller sizes, the d-spacings shrink to 9 Å. Note the presence of (130) peaks in the bottom two patterns indicate ABAB stacking. The a, b, and c lattice parameters are derived from the (200), (020), and (002) peaks, respectively (FIG. 1a). The b parameter is influenced by the nature of the intercalated cations, while the a and c parameters remain unaffected.

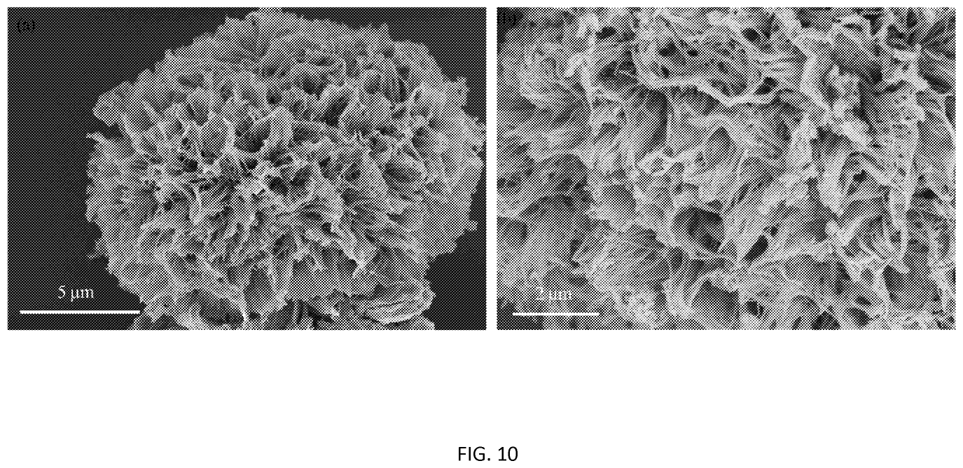

Sample SEM images of Na-PMP and K-PMP powders (FIGS. 1c and 10, respectively) show that both nanomaterials have the same semi-spherical, PMP morphology, composed of NFs exceeding 10 μm in lateral dimensions. The TEM image in FIG. 1b confirms that the colloid is comprised of quite fine NFs. The selected area electron diffraction, SAED, pattern (inset in FIG. 1b) displays distinct arcs rather than complete rings, clearly underscoring the anisotropic, 1D nature of our material.

### Antibacterial Activity

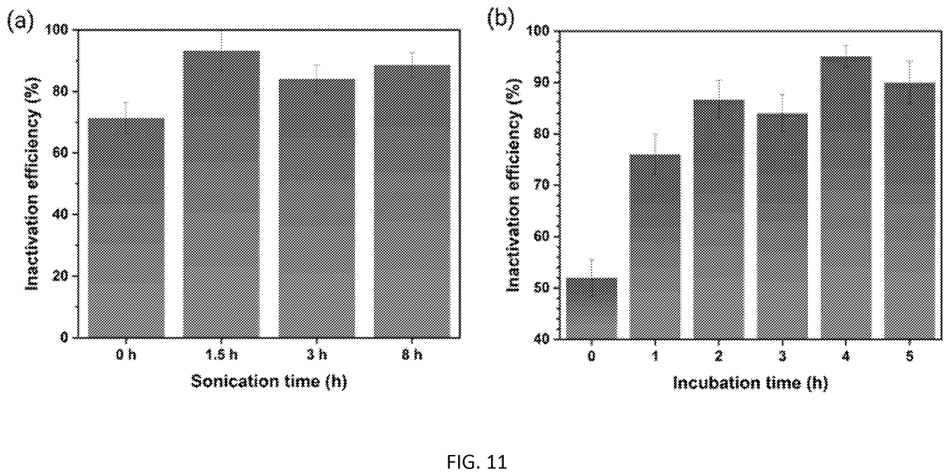

Previous studies have reported that the size of a nanomaterial can have important ramifications as to their ABA. To investigate this aspect, we bath sonicated colloidal suspensions to produce 1DL NFs of varying sizes, hypothesizing that longer sonication times would yield smaller/shorter NFs while preserving their chemical composition and surface properties. Accordingly, TMA-1DL colloids were sonicated for 1.5, 3, and 8 h. The AB activity of each suspension was assessed against E. coli (final concentration of 10⁶ CFU/mL) using the CFU method, with a fixed TMA-1DL NF concentration of 1000 μg/mL incubated with E. coli for 3 h. As shown in FIG. 11a, the percentage of E. coli inactivated increased from 71% for as-prepared TMA-1DL NFs to 92% for nanomaterials sonicated for 1.5 h. Further sonication did not increase this value and, unless otherwise noted, this is the sonication time used throughout. The lack of further enhancement with longer sonication times remains unclear and warrants additional investigation. The 1DL NFs intercalated with choline, K⁺, and Na⁺ were also subjected to 1.5 h of sonication under the same conditions. This trend may be attributed to changes in NF morphology. The sharp edges formed during sonication likely play a critical role in disrupting and penetrating bacterial cell walls, leading to cell damage and enhanced ABA. Similar observations have been reported with nanomaterials like graphene oxide and carbon nanotubes, where sharp edges or tubular structures insert into lipid bilayers, creating pores and disrupting membrane continuity, ultimately causing bacterial lysis.

To optimize the incubation times, 1.5 h sonicated TMA-1DL (at 1000 μg/mL) was tested against E. coli (10⁶ CFU/mL) over 0 to 5 h. As illustrated in FIG. 11b, bacterial inactivation efficiency increased steadily with longer incubation times, reaching approximately 96% in 4 h. Beyond this point, no significant improvement was observed, and at later point, inactivation efficiency decreased. This suggests that prolonged contact between NFs and bacterial cells enhances the AB effect, likely due to increased interaction or accumulation of reactive species at the bacterial surface. However, the decline observed beyond 4 h could be attributed to bacterial response mechanisms, such as the production of protective metabolites or activation of biological pathways that mitigate the AB effect. Additionally, an equilibrium may be established where the rate of bacterial killing is offset by bacterial growth, diminishing overall efficacy.

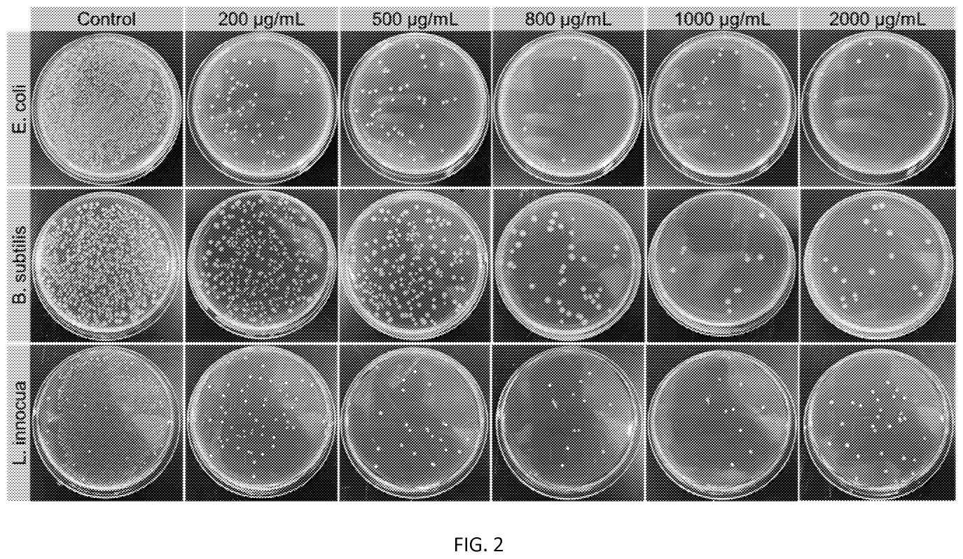

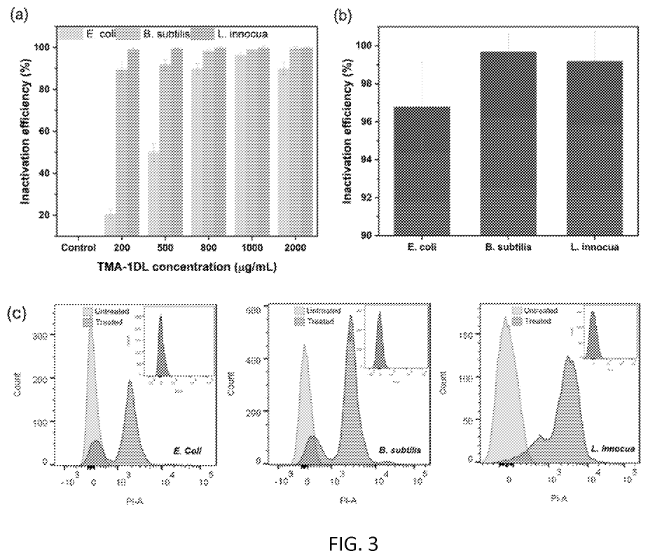

We further assessed the AB activity of TMA-1DL NFs against E. coli, B. subtilis, and L. innocua at concentrations of 200, 500, 800, 1000, and 2000 μg/mL, following 4 h of incubation using the CFU method. Agar plate photographs (FIG. 2) clearly demonstrate a reduction in bacterial colonies with increasing TMA-1DL concentrations. Quantitative analysis (FIG. 3a) revealed that E. coli exhibited a pronounced concentration-dependent inactivation, increasing significantly from 20.5% at 200 μg/mL to a maximum of 96.2% at 1000 μg/mL, with a slight decrease at higher concentrations. In contrast, B. subtilis showed moderate concentration dependence, with inactivation efficiency increasing from approximately 89% at 200 μg/mL to about 99% at 1000 μg/mL. L. innocua displayed minimal concentration dependence, maintaining consistently high inactivation efficiencies (99%) across all concentrations. These observed differences between these bacterial strains may be attributed to variations in their cell wall structures and/or compositions. E. coli, a Gram-negative bacterium, possesses an outer membrane that can act as a barrier to AB agents, potentially requiring higher concentrations of NFs for effective inactivation. Conversely, B. subtilis and L. innocua, both Gram-positive bacteria, lack this outer membrane, which may render them more susceptible to NF-induced membrane disruption, even at lower concentrations. Similar patterns of differential susceptibility have been reported in studies investigating the AB effects of natural compounds. For instance, vanillin exhibited varying minimum inhibitory concentrations (MICs) against E. coli and L. innocua, highlighting species-specific responses to antimicrobial agents. These findings underscore the importance of considering bacterial cell wall characteristics when evaluating the efficacy of nanomaterial-based AB agents.

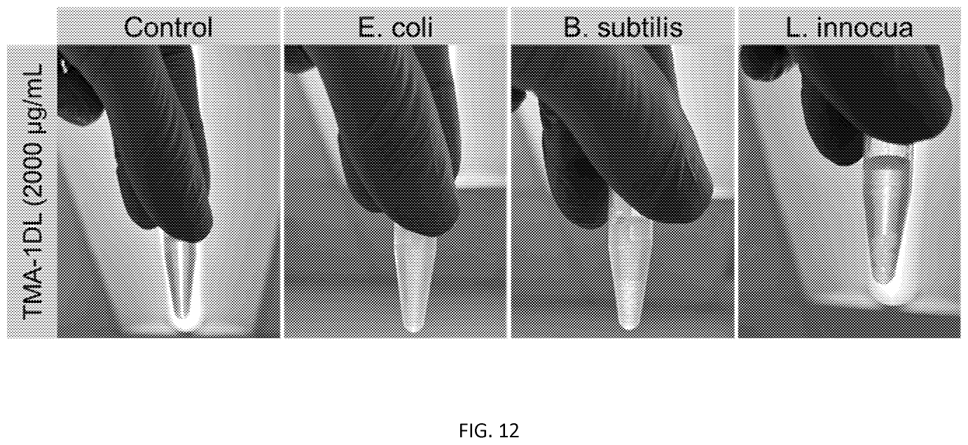

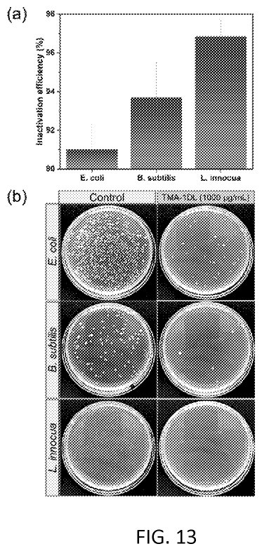

In summary, TMA-1DL NFs derived from pulverizing FFs exhibit excellent AB properties. Upon introducing TMA-1DL suspensions to bacterial cultures, visible agglomeration occurred almost immediately (FIG. 12). This phenomenon is likely due to the presence of cations, such as Na⁺, Cl⁻, K⁺, and phosphate ions in PBS, which increase ionic strength and can induce flocculation. Notably, when deionized (DI) water was used instead of PBS, flocculation did not occur, suggesting that ionic strength indeed plays a crucial role in NF aggregation. AB assays conducted in DI water, as shown in FIG. 13a-b, demonstrated inactivation efficiencies of 91%, 93.7%, and 96.8% for E. coli, B. subtilis, and L. innocua, respectively. These values are slightly lower than those observed in PBS, potentially due to the absence of flocculation in DI water, which may reduce direct interactions between the bacteria and the NFs. The higher ionic strength in PBS could enhance NF aggregation, increasing contact with bacterial cells and leading to higher inactivation efficiencies. Furthermore, some cells within these aggregates might be in a viable, but non-culturable, state affecting the observed AB activity. These findings underscore the importance of medium composition and ionic strength in modulating the AB efficacy of nanomaterials.

These attraction of the bacteria to 1DLs is somewhat unexpected because, at pH 7.4, the zeta potentials of E. coli cells (~−30 mV), B. subtilis (~−15 mV), and L. innocua (~−20 mV) are the same sign as the 1DL zeta potentials (−50 mV range), all negative. This similarity suggests that simple electrostatic repulsions should prevent electrostatic attractions between the bacteria and 1DL NFs. However, the observed agglomeration suggests that electrostatic screening by cations in PBS reduces repulsive interactions, allowing van der Waals forces, hydrophobic effects, or specific binding affinities to promote aggregate formation. These aggregates could be easily filtered out in PBS.

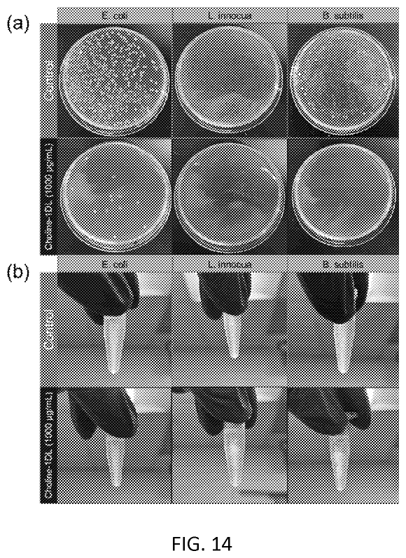

In pursuit of developing environmentally sustainable AB agents, we synthesized 1DL NFs using ChoOH instead of TMAOH. As shown in FIG. 3b, the resulting Cho-1DL NFs demonstrated significant AB efficacy, achieving inactivation efficiencies of approximately 96.8% for E. coli and 99% for both B. subtilis and L. innocua. Agar plate images (FIG. 14a) clearly illustrate the reduction in bacterial colonies across all three strains. Additionally, visible agglomeration in the treated bacterial suspensions was observed (FIG. 14b), here again indicating some interactions between the NFs and bacterial cells. These findings are particularly significant as they suggest that environmentally benign 1DL NFs can be readily produced using ChoOH, offering a safer alternative to TMAOH-based synthesis methods. This aligns with previous studies highlighting the AB properties of choline-based compounds. For instance, choline carboxylic acid-based ionic liquids have demonstrated notable AB activity, attributed to their ability to disrupt microbial cell membranes. Moreover, cholinium-based ionic liquids have been shown to possess excellent AB properties, comparable to standard antibiotics like streptomycin. The successful synthesis of Cho-1DL NFs not only imparts environmentally benign characteristics to the materials but also broadens their potential applications in biomedical fields, particularly applications where non-toxic but effective AB agents are required.

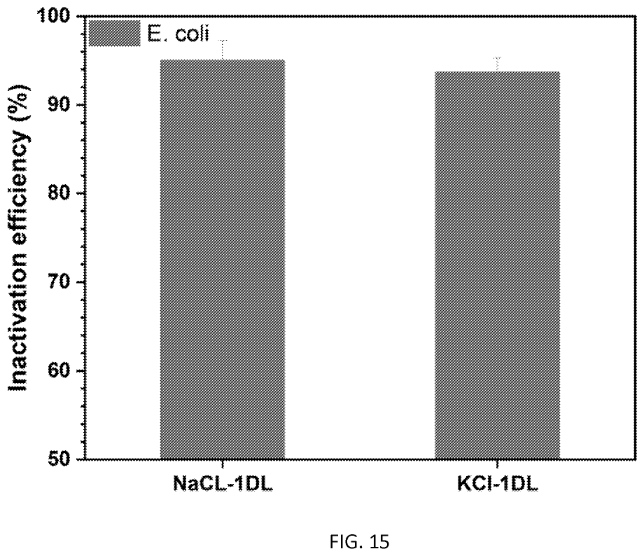

In a further set of experiments, we explored the potential of producing non-toxic PMPs by ion-exchanging TMA⁺ cations in 1DL NFs with Na⁺ and K⁺. The resulting Na-1DL and K-1DL PMPs demonstrated AB efficacy comparable to their TMA⁺-intercalated counterparts, as evidenced by the results presented in FIG. 15. Notably, due to their relatively larger size, these PMPs did not remain suspended for the 4 h duration of the AB assays. However, despite sedimentation they maintained high AB activity, suggesting that wet 1DL sediments in the form of PMPs could effectively inactivate bacteria. This observation opens the possibility of developing 1DL-based AB gels. Recent studies have shown that adding a few drops of acid to 1DL colloidal suspensions induces rapid gelation, resulting in hydronium-crosslinked inorganic hydrogels with good compressive strengths. We have also shown that simply adding common salt solutions to 1DL colloids can result in their gelation. The ability to ion-exchange TMA⁺ environmentally benign cations without compromising AB efficacy, coupled with the potential to form robust hydrogels, underscores the versatility of our materials. These findings suggest promising applications in environmental fields, particularly in developing antibacterial coatings and water purification systems.

Flow cytometry (FC) analyses were conducted on E. coli, B. subtilis, and L. innocua following a 4 h treatment with 1000 μg/mL of TMA-1DL NFs in the dark. The FC results, presented in FIG. 3c, reveal a substantial reduction in live bacterial cells post-treatment. Specifically, the percentage of live cells decreased from 97.2% to 15.1% for E. coli, from 98.1% to 12.9% for B. subtilis, and from 98.9% to 8.5% for L. innocua. These significant decreases indicate that our material can effectively damage bacterial cell membranes, leading to cell death even in the absence of light. FC analysis detects cells with compromised membranes as alive, whereas the CFU method considers them non-viable due to their inability to proliferate in growth media. This methodological difference accounts for the observed discrepancies in viability assessments between the two techniques. Nonetheless, both methods conclusively demonstrate that 1DL NFs possess potent AB properties in the dark, distinguishing them from traditional titanates and TiO₂, that require light activation for similar efficacy.

The slightly lower AB efficiency observed against E. coli compared to B. subtilis and L. innocua can be attributed to differences in their cell wall structures. E. coli, a Gram-negative bacterium, possesses a thinner peptidoglycan layer (7-8 nm) covered by an external protective lipid membrane, which provides additional resistance to antimicrobial agents. In contrast, Gram-positive bacteria like B. subtilis and L. innocua, have thicker peptidoglycan layers (20-80 nm) but lack the external lipid membrane, making their cell walls more susceptible to damage by direct contact with the 1DL nanostructured surfaces.

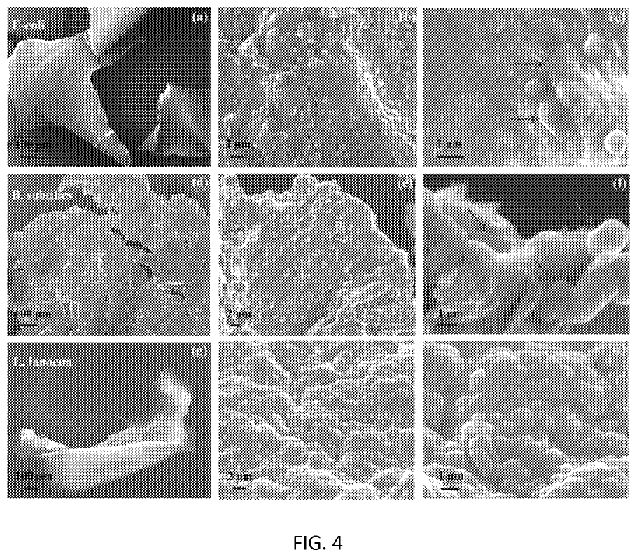

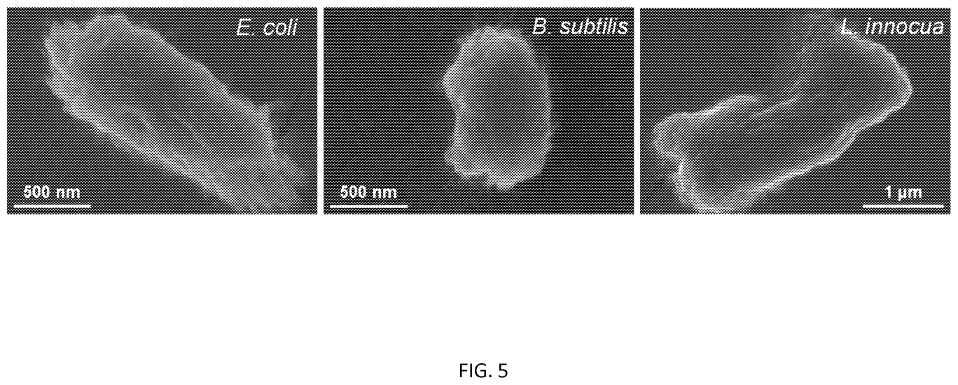

SEM images of the agglomerates (FIG. 4) offer valuable insights into the AB mechanisms of 1DL NFs. The images depict bacteria physically entrapped or enwrapped by the nm-thin 1DL NFs, leading to the formation of agglomerates. This suggests that at elevated concentrations, 1DL NFs likely entangle bacterial cells, restricting their mobility and resulting in their inactivation/death. Additionally, the sharp 1DL NF edges probably result in significant membrane damage, compromising cellular integrity and contributing to bacterial death. Further SEM analysis (FIG. 5) of bacterial cells treated with 1000 μg/mL TMA-1DL NFs reveals extensive cell lysis, characterized by severe membrane disruption and cytoplasmic leakage (highlighted by red arrows). These morphological alterations indicate direct interactions between the NFs and bacterial cells, leading to detachment of the cytoplasmic membrane from the cell wall and subsequent cellular collapse. Such observations align with the quantitative reductions in bacterial viability observed in both CFU assays and FC analyses (FIGS. 2 and 3c, respectively).

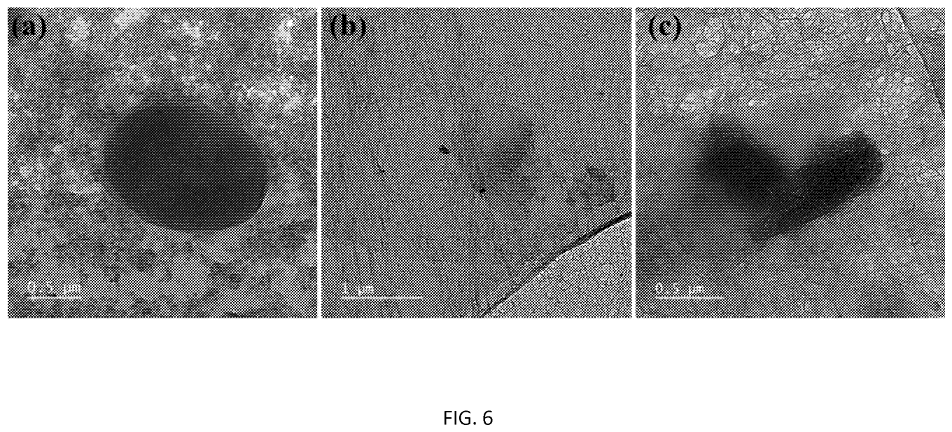

To provide additional evidence for direct membrane disruption as the primary AB mechanism we used a transmission electron microscope, TEM, to examine morphological changes in E. coli bacterial cells before, and after, exposure to the NFs. The untreated bacteria (FIG. 6a) exhibited intact cell membranes and well-defined morphologies. In contrast, significant morphological damage was evident upon treatment with 1DL NFs (FIGS. 6b and c), characterized by disrupted cell membranes and visible entanglement with the NFs. These findings visually corroborate our SEM observations (FIG. 5) and strongly support the conclusion that the ABA of the 1DL NFs predominantly arises from direct physical interactions with bacterial cell membranes.

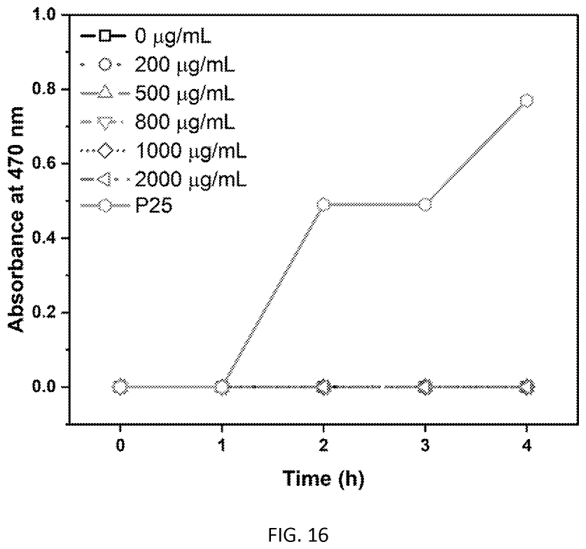

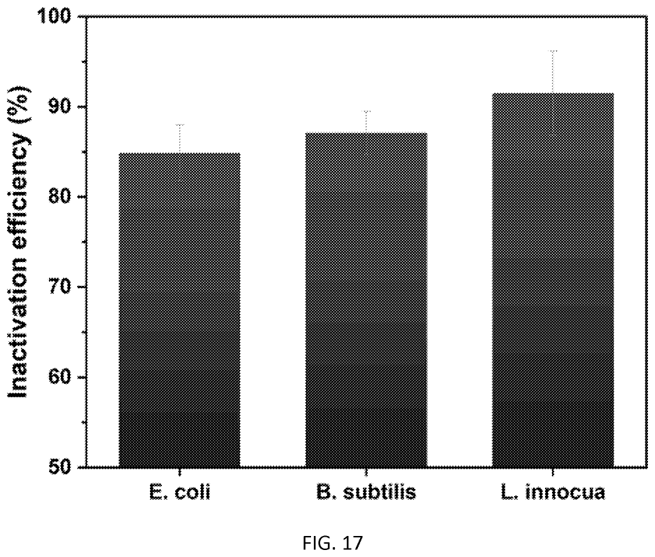

In past work where AB activity was observed in the dark, the presence of ROS was frequently invoked as the primary mechanism for bacterial destruction (Table 1). Because oxidative stress is widely proposed as a dominant AB mechanism for many nanomaterials containing metals, metal oxides, or carbon structures, it was reasonable to question whether a similar ROS-mediated mechanism could explain the AB activity of our 1DL NFs. To test this possibility, we quantified ROS generation in comparison with P25. Note that in the 1DL system ROS production would be proportional to any Ti cations with a charge <+4, e.g. Ti³⁺. However, we have previously shown that even if Ti³⁺ cations are present initially, they rapidly oxidize to +4. Said otherwise, if ROS are generated in the dark, their effect would be transient at best. To determine whether oxidative stress contributes to the AB activity of 1DL NFs, the generation of O^{2·-} was evaluated using an abiotic XTT reduction assay. As shown in FIG. 16, P25 (1000 μg/mL) exhibited a noticeable increase in absorbance at 470 nm over time, confirming its tendency to generate a small amount of O^{2·-}. In contrast, all 1DL NF samples, even at concentrations up to 2000 μg/mL, showed no measurable change in absorbance, indicating no detectable O^{2·-} generation. Despite the absence of detectable ROS production, our results demonstrate that TMA-1DL NFs exhibit substantial ABA in the dark, achieving reductions of 84.9%, 87.1%, and 91.5% against E. coli, B. subtilis, and L. innocua, respectively (FIG. 17). Given the environmentally benign nature of titanate-based materials, these findings strongly support direct membrane disruption, rather than ROS-mediated oxidative stress, as the dominant AB mechanism of 1DL NFs. This insight not only distinguishes 1DLs from conventional photoactivated titania-based AB agents but also expands their potential applications where light exposure is limited or undesirable, although the possible involvement of other ROS types cannot be fully excluded at this time.

Ion release from AB nanomaterials has also been recognized in the literature as a potential mechanism contributing to bacterial inactivation. To assess whether ionic dissolution contributes to the AB observed, inductively coupled plasma (ICP) analysis was conducted on aqueous suspensions of the 1DL NFs incubated under identical experimental conditions with each bacterial strain. The ICP results revealed minimal Ti ion release into the solution after 4 h of exposure, specifically 4.218 ppb, 0.406 ppb, and 0.21 ppb for suspensions containing L. innocua, B. subtilis, and E. coli, respectively. Given these very low Ti concentrations, it is reasonable to conclude that dissolved Ti is not a contributor to the AB activity. These findings further substantiate that direct physical membrane disruption is indeed the primary AB mechanism exerted by the 1DL NFs.

As summarized in the table below, a range of Ti-based AB materials based on anatase, rutile, and P25 can achieve high bacterial inactivation under optimized, strongly illuminated conditions, with several reports approaching ≈94-99% reduction of bacteria strains at loadings on the order of 100-1000 μg/mL. However, their performance under ambient light is markedly more variable, and in the dark the reported inactivation efficiencies generally fall to the ≈60-70% range at comparable concentrations and cell densities. By contrast, under comparable conditions, our 1DL NFs achieve 96-99% inactivation under ambient light and 85-92% in the dark, representing the highest intrinsic, light-independent AB efficacy reported for any Ti-based nanomaterial to date. This stark performance gap, reflected in the table provided herein, underscores that the antibacterial activity of 1DL NFs is primarily governed by contact-mediated physical membrane disruption rather than the ROS-dependent pathways characteristic of TiO₂-based systems, thereby enabling strong antibacterial activity even in the absence of photoactivation.

The hydrophilic surfaces of 1DL NFs likely facilitate close interfacial contact with bacterial membranes, thereby enhancing direct physical interactions. This intimate contact allows the nanometer-thin, sharp-edged filaments to exert mechanical stress on the cell envelope, leading to localized deformation, membrane rupture, and cytoplasmic leakage. These findings provide evidence that the antibacterial activity of 1DL NFs primarily arises from direct physical disruption of bacterial membranes rather than from electrostatic or chemical effects. While the term ‘quantum-confined’ describes the atomically thin one-dimensional nature of these titanate nanofilaments, the present results do not isolate quantum confinement itself as an independent antibacterial mechanism. Since both bacterial surfaces and 1DL NFs are negatively charged under physiological conditions, long-range electrostatic attraction is unlikely. Instead, the nanoscale thickness, high aspect ratio, and atomically sharp edges of the 1DL NFs enable efficient physical engagement with bacterial envelopes upon contact. This structural penetration mechanism explains the strong antibacterial activity observed even under dark conditions and is consistent with the minimal Ti ion release detected by ICP analysis. Collectively, these observations confirm that mechanical membrane disruption, rather than charge perturbation or photoinduced ROS generation, is the dominant antibacterial pathway for 1DL NFs.

It is important to note that, given that the ABA of 1DL NFs primarily arises from direct physical disruption of bacterial membranes rather than from chemical consumption of the active material, the NFs are not inherently depleted during antibacterial action. Furthermore, as noted above, these aggregates can be filtered out, and the ability to form hydronium-crosslinked inorganic hydrogels with good compressive strengths or to induce gelation by simply adding common salt solutions to 1DL colloids provides straightforward pathways for material recovery after use.

1DL colloidal dispersions are particularly relevant to applications such as water disinfection and microbial control in aqueous systems, as well as to precursor suspensions for antibacterial gels, coatings, or composite materials. Beyond dye interactions, it should be noted that 1DL PMPs exhibit remarkable capabilities in water purification, particularly in the adsorption of heavy metals. They rapidly adsorb actinides such as uranium (U⁴⁺) and thorium (Th⁴⁺), with adsorption capacities reaching up to 424 mg/g for U⁴⁺ and 292 mg/g for Th⁴⁺. These substantial capacities highlight the potential of 1DLs in transforming contaminated water into potable water.

TABLE 1
Comparison of antibacterial activities of titanate nanofilaments
with those of TiO₂-based materials reported in the literature.

| | | | Bacteria | | Bacteria reduction (%) | | | |
|---|---|---|---|---|---|---|---|---|
| | | Conc. | Conc. | | E. | B. | L. | |
| Material | Crystal form | (μg/mL) | (CFU/mL) | Condition | coli | subtilis | innocua | |
| TiO₂ | Anatase | 1000 | 10⁴ | UV-light | 98.5 | — | — | |
| TiO₂ | Rutile | 1000 | 10⁴ | UV-light | 93.7 | — | — | |
| TiO₂ | Anatase | 500 | 10⁶ | Normal light | 97 | — | — | |
| P25 TiO₂ | Anatase | 200 | 10⁸ | Normal light | 75 | — | — | |
| | Anatase | 100 | 6 * 10⁵ | Normal light | 45.6 | — | — | |
| TiO₂ | Anatase | 100 | 6 * 10⁵ | Normal light | 88.2 | — | — | |
| TiO₂ | Anatase | 200 | 10⁸ | UV-light | 99 | — | — | |
| TiO₂ | Anatase | 1000 | 10⁷ | Dark | 69.6 | — | — | |
| TiO₂ | Anatase | 1000 | 10⁷ | UV-light | 98.2 | — | — | |
| TiO₂ | Anatase | 5000 | 10⁷ | UV-light | 89.1 | 93 | — | |
| TiO₂ | Anatase | 150 | 10⁶ | Dark | — | 63 | — | |
| TiO₂ | Anatase/rutile | 1000 | 10⁸ | UV-light | — | 98 | — | |
| TiO₂ | — | 100 | 10⁶ | Normal light | 83.7 | 93.6 | — | |
| TiO₂ | Anatase | 2000 | 10⁸ | Normal light | 80 | 90 | — | |
| Titanate | N/A | 1000 | 10⁷ | UV-light | 99 | — | — | |
| Nanofiber* | | | | | | | | |
| Titanate | TMA-Lepidocrocite | 1000 | 10⁶ | Normal light | 96.2 | 98.9 | 99.8 | This |
| nanofilament | Chol-Lepidocrocite | | | Normal light | 96.8 | 99.7 | 99.2 | work |
| | TMA-Lepidocrocite | | | Dark | 84.9 | 87.1 | 91.5 | |

### Aspects

The following Aspects are illustrative only and do not limit the scope of the present disclosure or the appended Aspects. Any part or parts of any one or more Aspects can be combined with any part or parts of any one or more other Aspects.

Aspect 1. A method of bacterial population inactivation, comprising: contacting the bacterial population and a plurality of one-dimensional lepidocrocite titanate nanofilaments under such conditions that at least a portion of the bacterial population is inactivated.

The one-dimensional lepidocrocite titanate nanofilaments can be, for example, made according to the present disclosure. Suitable such nanofilaments are also described in U.S. patent application Ser. No. 19/103,604 and U.S. patent application Ser. No. 18/448,593, both of which are incorporated herein by reference for any and all purposes.

The one-dimensional lepidocrocite titanate nanofilaments can have a lepidocrocite-type crystal structure defined by edge-sharing TiO₆ octahedra arranged in a one-dimensional morphology, and the nanofilaments can have atomically thin cross-sections and lengths of tens of nanometers. Without being bound to any particular theory or embodiment, the nanofilaments can inactivate bacteria through direct physical interaction with bacterial cell membranes, which interaction can take place in the absence of photoactivation. The interaction can, for example, cause membrane disruption and loss of cell viability. The described inactivation can take place under ambient light or dark conditions, and can take place without reliance on reactive oxygen species generation or metal ion release.

The one-dimensional lepidocrocite titanate nanofilaments can be comprised in a liquid, a gel, in particles, or in other carriers. As but some examples, the one-dimensional lepidocrocite titanate nanofilaments can be comprised in a gel, akin to a hand-sanitizer gel. The one-dimensional lepidocrocite titanate nanofilaments can also be comprised in a liquid, which liquid can be diluted into water or other solvents. The one-dimensional lepidocrocite titanate nanofilaments can thus be applied to a sample or a surface in the manner of a soap.

The one-dimensional lepidocrocite titanate nanofilaments can be comprised in a soap solution, such as a hand-washing soap, dish soap, or other soap solution. The one-dimensional lepidocrocite titanate nanofilaments can be comprised in a pervious material. Such a pervious material can be, for example, a sponge or a filtration medium.

The one-dimensional lepidocrocite titanate nanofilaments can be used, for example, to disinfect a surface of an article, such as a surface of an instrument, a surface of a utensil, a surface of a tableware item, and the like. The one-dimensional lepidocrocite titanate nanofilaments can be used to disinfect a liquid sample, for example, stream water or river water. The one-dimensional lepidocrocite titanate nanofilaments are also useful in wound care, for example, to disinfect or pre-emptively disinfect skin, bone, or other tissue. The one-dimensional lepidocrocite titanate nanofilaments can be contacted to a wound, such as a cut, a bed sore, a surgical incision, and the like.

As explained elsewhere herein, the one-dimensional lepidocrocite titanate nanofilaments can be comprised in a gel that is applied, a solution that is applied, and in other carriers. Without being bound to any particular theory or embodiments, the one-dimensional lepidocrocite titanate nanofilaments can be comprised in a wound dressing that is in turn applied to a wound. Such a dressing can be, for example, an adhesive bandage, a pressure dressing, and the like.

Aspect 2. The method of Aspect 1, wherein the contacting is performed under ambient illumination. The contacting can take place under reduced limitation or even in dim lighting or darkness.

Aspect 3. The method of any one of Aspects 1-2, wherein the contacting is performed for less than about 5 hours. The contacting can be for up to 5 hours, for up to 4.5 hours, for up to 4 hours, for up to 3.5 hours, for up to 3 hours, for up to 2.5 hours, for up to 2 hours, for up to 1.5 hours, or even for up to 1 hour.

Aspect 4. The method of any one of Aspects 1-3, further comprising agitating the bacterial population and the plurality of one-dimensional lepidocrocite titanate nanofilaments. Agitation can be, for example, by shaking, by sonication, by a mixing element, and the like.

Aspect 5. The method of any one of Aspects 1-4, wherein the plurality of one-dimensional lepidocrocite titanate nanofilaments are sonicated. Such nanofilaments can be sonicated before contacting the bacterial population.

Aspect 6. The method of any one of Aspects 1-5, wherein the contacting effects inactivation of up to 99% of the bacterial population. The contacting can effect inactivation of up to 99% of the bacterial population, or up to 98% of the bacterial population, or up to 97% of the bacterial population, or up to 96% of the bacterial population, or up to 95% of the bacterial population, or up to 94% of the bacterial population, or up to 93% of the bacterial population, or up to 92% of the bacterial population, or up to 91% of the bacterial population, or up to 90% of the bacterial population.

Aspect 7. The method of Aspect 6, wherein the contacting effects inactivation of up to 95% of the bacterial population.

Aspect 8. The method of Aspect 7, wherein the contacting effects inactivation of up to 90% of the bacterial population.

Aspect 9. The method of any one of Aspects 1-8, wherein the contacting effects inactivation of at least 50% of the bacterial population.

Aspect 10. The method of any one of Aspects 1-9, wherein the contacting is performed in the presence of a buffer.

Aspect 11. The method of any one of Aspects 1-10, wherein the bacterial population comprises at least one of Escherichia coli, Bacillus subtilis, and Listeria innocua. The foregoing bacterial types are illustrative only and are not limiting, as the disclosed technology can be effective against other types of bacteria.

Aspect 12. The method of any one of Aspects 1-11, wherein the plurality of one-dimensional lepidocrocite titanate nanofilaments are derived from reacting titanium with tetramethylammonium hydroxide (TMAOH). An example of such a process is provided elsewhere herein.

Aspect 13. The method of any one of Aspects 1-11, wherein the plurality of one-dimensional lepidocrocite titanate nanofilaments are derived from reacting titanium with choline hydroxide (ChoOH). An example of such a process is provided elsewhere herein.

Aspect 14. The method of any one of Aspects 1-13, wherein the plurality of one-dimensional lepidocrocite titanate nanofilaments are comprised in porous mesostructured particles.

Aspect 15. A composition, comprising: a bacterial population; and a plurality of one-dimensional lepidocrocite titanate nanofilaments.

Aspect 16. The composition of Aspect 15, further comprising a buffer. Example buffers include, without limitation, phosphate-buffered saline, HEPES buffer, bicarbonate buffer, Tris-buffered saline, Hank's Balanced Salt Solution, Earle's Balanced Salt Solution, and MES buffer, as some non-limiting examples.

Aspect 17. The composition of any one of Aspects 15-16, wherein the bacterial population comprises at least one of Escherichia coli, Bacillus subtilis, and Listeria innocua.

Aspect 18. The composition of any one of Aspects 15-17, further comprising alkali metal ions intercalated into the plurality of one-dimensional lepidocrocite titanate nanofilaments.

Aspect 19. The composition of Aspect 18, wherein the alkali metal ions comprises at least one of Na and K. Other suitable alkali metal ions include Li, Rb, Cs, and Fr. Na and K, however, are considered particularly suitable.

Aspect 20. The composition of any one of Aspects 15-19, wherein the plurality of one-dimensional lepidocrocite titanate nanofilaments are comprised in porous mesostructured particles.

Aspect 20. An antibacterial surface comprising: a substrate; and a coating disposed on the substrate, the coating comprising one-dimensional lepidocrocite titanate nanofilaments, the nanofilaments being configured to mechanically disrupt bacterial cell membranes with contact.

The antibacterial activity of the surface can be independent of ultraviolet or visible light activation. Such a coating can comprise, for example, one-dimensional lepidocrocite titanate nanofilaments disposed in a polymeric or other matrix. In some instances, the one-dimensional lepidocrocite titanate nanofilaments can be incorporated directly into a surface of the substrate, as the one-dimensional lepidocrocite titanate nanofilaments need not necessarily be incorporated into a coating that is disposed on the substrate. A surface can be comprised in, without limitation, a medical device, a water treatment component, a furnishing, a filtration component, and the like.

Aspect 21. An antibacterial material comprising: a gel or porous mesostructured particle comprising one-dimensional lepidocrocite titanate nanofilaments, the nanofilaments being configured to mechanically disrupt bacterial cell membranes with contact.

Without being bound to any particular theory or embodiment, the nanofilaments can be intercalated with alkali metal cations or other cations; alkali metal cations are considered especially suitable.

Aspect 22. A purification system, comprising: a filtration medium containing one-dimensional lepidocrocite titanate nanofilaments, the nanofilaments being configured to mechanically disrupt bacterial cell membranes with contact. The filtration medium can be operable to remove or immobilize bacteria without requiring additional chemical disinfectants, light activation, or release of bactericidal ions into the water.

Aspect 23. A component, comprising: a substrate; and one-dimensional lepidocrocite titanate nanofilaments disposed in or on the substrate, the nanofilaments being configured to mechanically disrupt bacterial cell membranes with contact, and the one-dimensional lepidocrocite titanate nanofilaments optionally being comprised in a coating. The component can be comprised in, for example, any one or more of a medical device, a water treatment component, a furnishing, and a filtration medium.

The one-dimensional lepidocrocite titanate nanofilaments can be, for example, comprised in a coating that is disposed on the substrate. The one-dimensional lepidocrocite titanate nanofilaments can be, for example, incorporated directly to the material of the substrate. The one-dimensional lepidocrocite titanate nanofilaments can be, for example, present as a suspension that is within a pervious material, such as a sponge or a wound dressing. The one-dimensional lepidocrocite titanate nanofilaments can also be present as placed directly onto the substrate, for example, placed directly onto the fibers of a fibrous wound dressing. As explained elsewhere herein, the one-dimensional lepidocrocite titanate nanofilaments can be used in wound care applications, among various other disinfection applications. A binder or other material can be present to secure the one-dimensional lepidocrocite titanate nanofilaments to the substrate, but this is not a requirement.

Aspect 24. A method, comprising: suspending a plurality of one-dimensional lepidocrocite titanate nanofilaments so as to give rise to an antibacterial suspension of the one-dimensional lepidocrocite titanate nanofilaments. The one-dimensional lepidocrocite titanate nanofilaments can be disposed, for example, in any one or more of a gel, a liquid, and a particle. As an example, the one-dimensional lepidocrocite titanate nanofilaments can be disposed in a carrier that is itself in turn disposed within a shell or other protective feature that prevents release of the contents until the desired time.

As described elsewhere herein, the one-dimensional lepidocrocite titanate nanofilaments can be disposed in a carrier—such as a viscous liquid—that is then applied to a desired location for disinfection. This application can be accomplished by, for example, spraying, rubbing, wiping, dripping, and the like. As but one example, one-dimensional lepidocrocite titanate nanofilaments can be introduced to a sponge or other carrier, which carrier is then contacted to the surface to be disinfected.

Aspect 25. The method of Aspect 24, further comprising disposing the antibacterial suspension in a carrier.

Aspect 26. The method of Aspect 25, wherein the carrier comprises a pervious material.

Aspect 27. The method of Aspect 26, wherein the pervious material comprises a sponge or a filtration medium.

What is claimed:

1. A method of bacterial population inactivation, comprising:
contacting a bacterial population and a plurality of one-dimensional lepidocrocite titanate nanofilaments under such conditions that at least a portion of the bacterial population is inactivated.

2. The method of claim 1, wherein the contacting is performed under ambient illumination.

3. The method of claim 1, wherein the contacting is performed for less than about 5 hours.

4. The method of claim 1, further comprising agitating the bacterial population and the plurality of one-dimensional lepidocrocite titanate nanofilaments.

5. The method of claim 1, wherein the plurality of one-dimensional lepidocrocite titanate nanofilaments are sonicated.

6. The method of claim 1, wherein the contacting effects inactivation of up to 99% of the bacterial population.

7. The method of claim 1, wherein the one-dimensional lepidocrocite titanate nanofilaments are comprised in a pervious material, the pervious material optionally comprising a sponge or a filtration medium.

8. The method of claim 1, wherein the one-dimensional lepidocrocite titanate nanofilaments are comprised in a liquid or a gel.

9. The method of claim 1, wherein the bacterial population comprises at least one of Escherichia coli, Bacillus subtilis, and Listeria innocua.

10. The method of claim 1, wherein the plurality of one-dimensional lepidocrocite titanate nanofilaments are derived from reacting a titanium-containing precursor with TMAOH.

11. The method of claim 1, wherein the plurality of one-dimensional lepidocrocite titanate nanofilaments are derived from reacting a titanium-containing precursor with ChoOH.

12. The method of claim 1, wherein the plurality of one-dimensional lepidocrocite titanate nanofilaments are comprised in porous mesostructured particles.

13. A composition, comprising:
a bacterial population; and
a plurality of one-dimensional lepidocrocite titanate nanofilaments.

14. The composition of claim 13, wherein the bacterial population comprises at least one of Escherichia coli, Bacillus subtilis, and Listeria innocua.

15. The composition of claim 13, further comprising alkali metal ions intercalated into the plurality of one-dimensional lepidocrocite titanate nanofilaments.

16. A component, comprising:
a substrate; and
one-dimensional lepidocrocite titanate nanofilaments disposed in or on the substrate,
the one-dimensional lepidocrocite titanate nanofilaments configured to mechanically disrupt bacterial cell membranes with contact, and
the one-dimensional lepidocrocite titanate nanofilaments optionally being comprised in a coating.

17. The component of claim 16, wherein the component is comprised in any one or more of a medical device, a water treatment component, a furnishing, and a filtration medium.

18. A method, comprising: suspending a plurality of one-dimensional lepidocrocite titanate nanofilaments so as to give rise to an antibacterial suspension of the one-dimensional lepidocrocite titanate nanofilaments.

19. The method of claim 18, further comprising disposing the antibacterial suspension in a carrier.

20. The method of claim 19, wherein the carrier comprises a pervious material.
